(19) United States
(12) Patent Application Publication
(10) Pub. No.: US 2026/0220347 A1
(43) Pub. Date: Jul. 30, 2026

(54) ROTATABLE CHIPLETS

(71) Applicant: MICROSOFT TECHNOLOGY LICENSING, LLC, Redmond, WA (US)

(72) Inventor: Derek T. CHIOU, Austin, TX (US)

(21) Appl. No.: 19/041,911

(22) Filed: Jan. 30, 2025

(51) Int. Cl. G06F 30/392; G06F 119/22

(52) U.S. Cl. CPC G06F 30/392; G06F 2119/22

(57) ABSTRACT

Methods and apparatuses for improving the yield and performance of integrated circuit structures by utilizing rotatable chiplets are described. During manufacturing of an integrated circuit structure that includes multiple chiplets arranged within a plurality of integration layers, each integration layer may be dynamically rotated or oriented prior to being bonded based on chiplet characteristics of the chiplets within the integration layers. Each integration layer comprises one or more chiplets. An automated manufacturing system determines the degree of rotation of a first integration layer relative to a second integration layer to which the first integration layer is to be directly or indirectly attached based on chiplet performance, capacity, and/or thermal characteristics of the chiplets within the integration layers.

### BACKGROUND

Integrated circuits (ICs) are widely used in various electronic devices such as mobile computing devices, smartphones, personal digital assistants, medical electronics, and hardware servers. Integrated circuits are commonly implemented on an integrated circuit chip, today most commonly implemented in silicon. An integrated circuit chip may also be referred to as an integrated circuit (IC), die, chiplet, or tile, where the last two terms, chiplet and tile, are often used to indicate it will be assembled together with others in a single package. Although a plural form of “die” is “dice,” it is a common industry practice to use “die” as a plural form as well as the singular form. In most cases, die are placed in a package. Multiple die can be placed into a single package and connected together to create a bigger circuit across those multiple die. Common packages include surface-mount packages (e.g., a BGA package or TSOP package), stacked multi-chip packages, and chip stack multichip modules (MCMs).

### BRIEF SUMMARY

The semiconductor industry is entering a new era where traditional methods of device scaling and cost reduction are no longer sustainable. Increasing the number of transistors on a single monolithic IC has become increasingly challenging and costly with each new technology node. Integrating multiple functions into a single monolithic chip as a system on a chip (SoC) also poses significant challenges including higher fabrication costs, lower yields, and increased design complexities. An alternative approach is heterogeneous integration that utilizes advanced packaging techniques to integrate multiple chiplets that are independently designed and manufactured using the most suitable and optimized process technology for each individual chiplet.

Systems and methods are provided for improving the yield, performance, and thermal characteristics of integrated circuit structures by utilizing rotatable chiplets. The rotatable chiplets may be arranged within one or more integration layers that are vertically aligned with each other. In some embodiments, an integrated circuit structure includes multiple chiplets arranged within a plurality of integration layers. Each integration layer of the plurality of integration layers is rotated or oriented relative to a base integration layer based on chiplet characteristics of the multiple chiplets. In one example, a first orientation (e.g., associated with a 90-degree rotation) of a first integration layer of the plurality of integration layers maximizes system performance. In another example, a second orientation (e.g., associated with a 180-degree rotation) of the first integration layer of the plurality of integration layers maximizes thermal gradients between the multiple chiplets.

In some embodiments, during manufacturing of an integrated circuit structure that includes multiple chiplets arranged within a plurality of integration layers, one or more integration layers may be rotated or oriented prior to being attached (e.g., bonded) based on the characteristics of the chiplets within the integration layers. Each integration layer comprises one or more chiplets, and may also comprise a substrate or interposer (e.g., a silicon interposer) onto which the one or more chiplets are bonded or attached. An automated manufacturing system may determine the degree of rotation (e.g., 0 degrees, 90 degrees, 180 degrees, or 270 degrees) of an integration layer relative to the next integration layer to which the first integration layer is to be directly or indirectly attached (e.g., via hybrid bonding or fusion bonding) based on chiplet characteristics of the chiplets within the integration layers. The chiplet characteristics may include the number of chiplet defects, chiplet performance metrics (e.g., the clock frequency or the number of usable cores), chiplet capacity metrics (e.g., the usable memory size), and/or chiplet thermal metrics (e.g., the average chiplet temperature or maximum operating temperature).

According to some embodiments, the technical benefits of the systems and methods disclosed herein include reduced power and energy consumption during operation, improved battery life, increased system performance, and reduced manufacturing costs. Other technical benefits can also be realized through various implementations of the disclosed technologies.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Like-numbered elements may refer to common components in the different figures.

FIG. 1A depicts embodiments of integration layers that include multiple chiplets with different degrees of rotation.

FIGS. 1B-1C depict embodiments of side views of vertically adjacent integration layers.

FIGS. 1D-1E depict embodiments of top plan views of vertically adjacent integration layers.

FIGS. 1F-1G depict embodiments of integration layers that include multiple chiplets that are of a circular shape with different degrees of rotation.

FIGS. 1H-1I depict embodiments of vertically adjacent integration layers, wherein the integration layers include chiplets with non-rectangular shapes.

FIG. 2A depicts one embodiment of an integrated circuit structure that includes multiple integration layers.

FIG. 2B depicts one embodiment of a portion of an integrated circuit structure that includes multiple integration layers.

FIG. 2C depicts an alternative embodiment of a portion of an integrated circuit structure that includes multiple integration layers.

FIG. 3A depicts one embodiment of a networked computing environment in which the disclosed technology may be practiced.

FIG. 3B depicts a flowchart describing one embodiment of a process for manufacturing an integrated circuit structure with rotatable chiplets.

### DETAILED DESCRIPTION

The technologies described herein improve the yield, performance, and thermal characteristics of three-dimensional integrated circuit structures by utilizing rotatable chiplets. In some cases, an integrated circuit structure includes multiple chiplets arranged within a plurality of integration layers that are stacked on top of each other. Each integration layer comprises one or more chiplets and/or a substrate or interposer (e.g., a silicon interposer) onto which the one or more chiplets are bonded or attached. In some embodiments, an integration layer does not include a substrate or interposer.

In some cases, integration layers within a vertical stack of integration layers are oriented in one way (e.g., 0 degrees), and are designed accordingly. However, rather than having each integration layer always be oriented in the same way relative to each other, the disclosed technology allows each integration layer to be rotated with respect to the layer above and below it, and, subsequently, with layers beyond the layers immediately above and below it. For square-shaped chiplets, there are four prominent rotations of 0 degrees, 90 degrees, 180 degrees, and 270 degrees (or –90 degrees). For rectangular-shaped chiplets, there are two prominent rotations of 0 degrees and 180 degrees. With a hexagonally shaped chiplet, there are six prominent rotations, and so on. If packaging allows, any shape chiplet could be rotated at any angle relative to other chiplets. Note that chiplets do not need to be the same size to be rotated on top of each other. For example, consider a rectangular integration layer of dimension 2x1 and two square integration layers, each 1x1. The two square integration layers could each be rotated independently of the other on top of the rectangular integration layer.

The chiplets and/or integration layers may be designed to enable rotation. In one example, circuitry on the chiplets and/or the connecting layers between chiplets that connect chiplets in the X, Y, and Z dimensions is configured to accommodate two or more rotations. One reason to enable different degrees of rotation is to change which chiplets are stacked on top of each other and, therefore, what chiplets are closer to each other.

In one example, consider a square chiplet with four quadrants that are labeled A, B, C, and D in a clockwise fashion starting from the upper left quadrant. In this case, the A and C quadrants are furthest apart and will remain far apart if the same square chiplets are stacked at a 0-degree rotation. However, if a first square chiplet is rotated by 180 degrees relative to a second square chiplet positioned below the first square chiplet, then the C quadrant of the first square chiplet will be vertically aligned with the A quadrant of the second square chiplet, thereby significantly reducing the vertical distance between circuits within the A quadrant of the second square chiplet and circuits within the C quadrant of the first square chiplet. The 180-degree rotation also vertically aligns circuits within the C quadrant of the second square chiplet with circuits within the A quadrant of the first squire chiplet.

As the vertical distance between the A quadrant of the second square chiplet and the C quadrant of the first square chiplet may be significantly less than the horizontal distance between the A quadrant of the second square chiplet and the C quadrant of the second square chiplet, the ability to rotate integration layers and/or chiplets by different degrees of rotation in a vertical stack can improve the performance and thermal properties for chiplets within the vertical stack. Moreover, the ability to rotate integration layers and/or chiplets by different degrees of rotation in a vertical stack can improve yields of integrated circuit structures that include vertical stacks of chiplets.

In some embodiments, during manufacturing of an integrated circuit structure, chiplets within integration layers of the integrated circuit structure are rotated prior to being bonded or electrically coupled to the integrated circuit structure. In one example, an integrated circuit structure includes multiple chiplets arranged within a plurality of integration layers, wherein one or more of the integration layers is rotated or oriented prior to being bonded based on chiplet characteristics of the chiplets within the integration layers.

In some embodiments, an automated manufacturing system determines the degree of rotation of a one integration layer relative to the next integration layer to which the first integration layer is to be directly or indirectly attached based on chiplet characteristics of the chiplets within the integration layers. The chiplet characteristics include the number of chiplet defects, chiplet process metrics (e.g., transistor characteristics for a chiplet), chiplet performance metrics (e.g., the clock frequency or the number of usable cores), chiplet capacity metrics (e.g., the usable memory size), and/or chiplet thermal metrics (e.g., the average chiplet temperature or maximum operating temperature).

In some cases, chiplet characteristics are determined at wafer sort, pre-bond testing, or prior to IC packaging, and the chiplet characteristics are used to bin the chiplets according to various performance characteristics. Due to manufacturing variations, the same chiplet design may yield chiplets with different performance characteristics. In one example, processor core chiplets fabricated on a wafer or across multiple wafers (e.g., wafer lots) are tested and sorted into multiple bins that correspond to the clock frequency, the number of usable cores, the number of threads, and the amount of Level 3 (L3) cache. In another example, memory chiplets are tested and sorted into multiple bins that correspond to memory size, read performance, and write performance.

In some cases, chiplets are classified as a 100% version or a 75% version with reduced performance or capacity. In one example, a 100% version of a core chiplet comprises a core chiplet with at least four usable cores and a clock frequency of at least 3.2GHz; a 75% version of the core chiplet comprises a core chiplet with at least three usable cores and a clock frequency of at least 2.4GHz; otherwise, the core chiplet won’t be used or integrated. In another example, a 100% version of a memory chiplet comprises a memory chiplet with at least 32GB of memory capacity and at least 200 GB/s memory bandwidth; a 75% version of the memory chiplet comprises a memory chiplet with at least 24GB of memory capacity and at least 150 GB/s memory bandwidth; otherwise, the memory chiplet won’t be used or integrated.

As an integration layer is rotated, the chiplets within the integration layer are also rotated. In one embodiment, the degree of rotation of an integration layer to be arranged above another integration layer is set to maximize the number of 100% chiplet versions that are vertically aligned. In another embodiment, the degree of rotation of an integration layer to be arranged above another integration layer is set to maximize the performance (e.g., the highest clock frequencies and/or number of usable cores) of chiplets that are vertically aligned. In another embodiment, the degree of rotation of an integration layer to be arranged above another integration layer is set to maximize the amount of usable memory capacity that is vertically aligned. In another embodiment, the degree of rotation of an integration layer to be arranged above another integration layer is set to maximize the thermal gradients of chiplets that are vertically aligned. Thermal gradients are maximized when cold chiplets are placed close to hot chiplets.

In some embodiments, each integration layer is partitioned into four equal quadrants. Each quadrant includes one or more chiplets. In some cases, the degree of rotation of an integration layer to be arranged above another integration layer is set to maximize the number of vertically aligned quadrants that contain core chiplets with at least a threshold clock frequency and/or at least a threshold number of cores. In some cases, the degree of rotation of an integration layer to be arranged above another integration layer is set to maximize the number of vertically aligned quadrants that contain memory chiplets with at least a threshold amount of memory capacity and/or at least a threshold memory bandwidth.

In one embodiment, an integration layer includes one or more chiplets that comprise heterogeneous die, such as a core die that includes multiple processor cores, a memory cache die (e.g., comprising DRAM, SRAM, or Flash memory), and an FPGA die. In some cases, the chiplets within integration layers are stacked vertically in a fixed orientation. In other cases, the chiplets within integration layers are stacked vertically with a rotated orientation relative to the chiplets within a base integration layer. In one example, two vertically adjacent integration layers are rotated by 45 degrees, 60 degrees, 90 degrees, 180 degrees, or 270 degrees relative to each other.

The technical benefits of utilizing rotatable chiplets include improving heterogeneous integration, improving yield while maintaining performance, enabling an eco-system of chiplets, and enabling the manufacture of customized products with optimized performance, power, and thermal characteristics. In some cases, an integrated circuit structure with rotatable chiplets has 100% chiplet versions and 75% chiplet versions (e.g., chiplet versions that have silicon defects impacting 25% of their performance or memory capacity). The ability to rotate chiplets such that 100% chiplet versions vertically align with each other improves the overall performance of the system implemented by the integrated circuit structure.

In one embodiment, the rotated orientation for an integration layer causes a first chiplet within a first integration layer to be vertically aligned with a second chiplet within a second integration layer abutting or adjacent to the first integration layer. Both the first chiplet and the second chiplet comprise 100% chiplet versions. In one example, the first chiplet is a core die and the second chiplet is a memory die. In another example, the first chiplet is a die with multiple processor cores and the second chiplet is a memory cache die.

In some cases, one or more integration layers that are vertically aligned with each other are rotated or oriented based on chiplet performance characteristics. As examples, the chiplet performance characteristics include data latency between two chiplets on different integration layers, data throughput between two chiplets on different integration layers, read/write latency between two chiplets on different integration layers, the electrical distance or line impedance for data lines between two chiplets on different integration layers, and/or the physical distance between two chiplets on different integration layers. In some cases, the two chiplets on different integration layers comprise two chiplets on adjacent or abutting integration layers. In other cases, the two chiplets on different integration layers have an intervening integration layer between the two different integration layers. The physical distance between two chiplets may correspond to the minimum distance between any portion of a first chiplet to any portion of a second chiplet or to the distance between the chiplet centers for the two chiplets. The physical distance between two chiplets relates to the locality of the two chiplets.

In some embodiments, the ability to rotate or orient one or more integration layers allows for stacks of integration layers or stacks of chiplets that have different overall performance metrics. In one example, different rotations of a first integration layer within a stack of integration layers correspond to different chiplet performance characteristics, different chiplet thermal characteristics, and different chiplet power characteristics. Moreover, the ability to rotate or orient one or more integration layers allows for stacks of integration layers or stacks of chiplets enables the creation of different products with different performance characteristics.

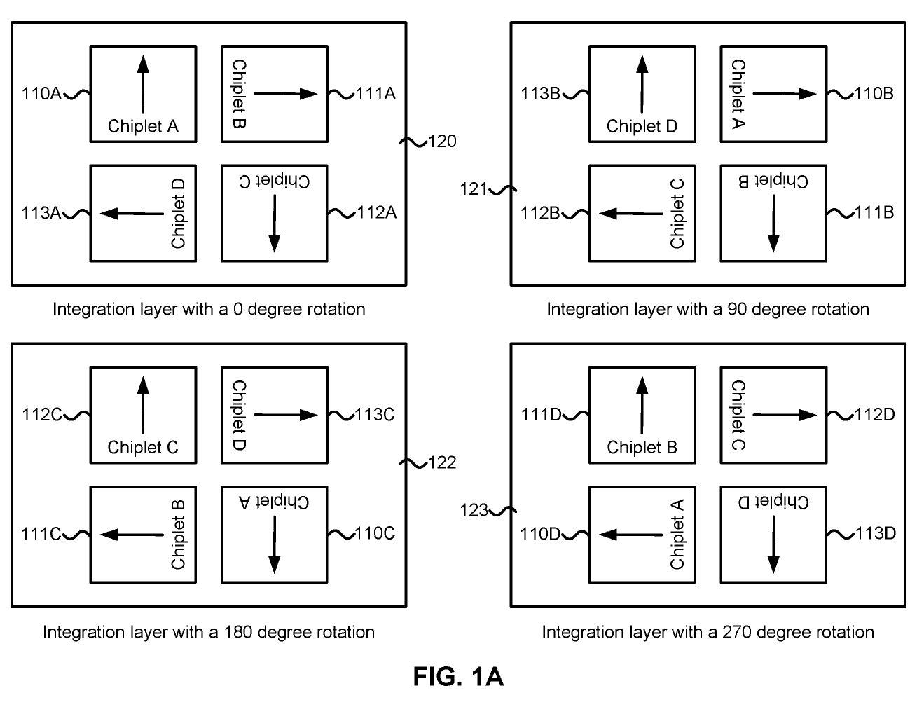

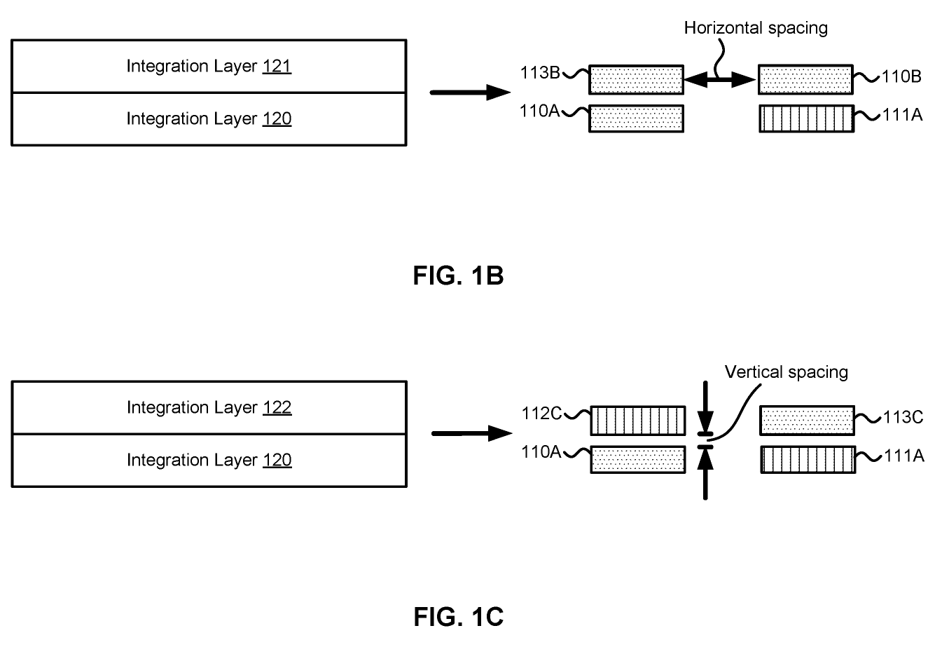

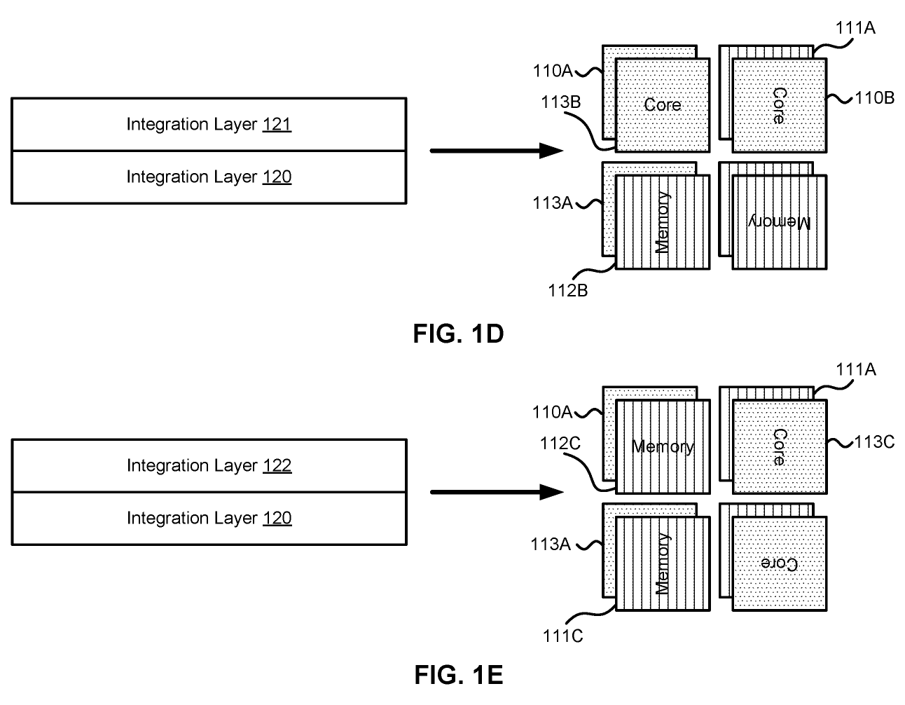

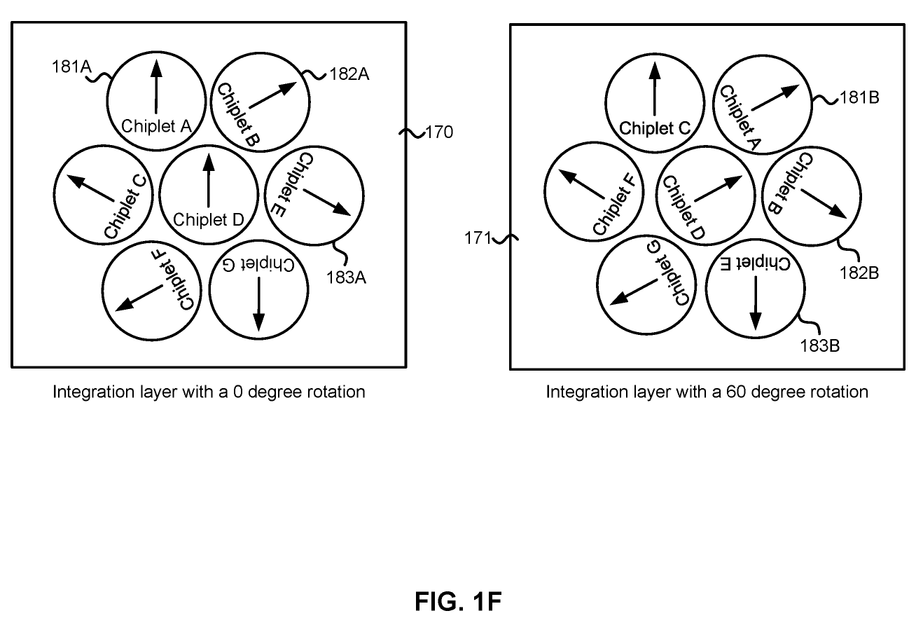

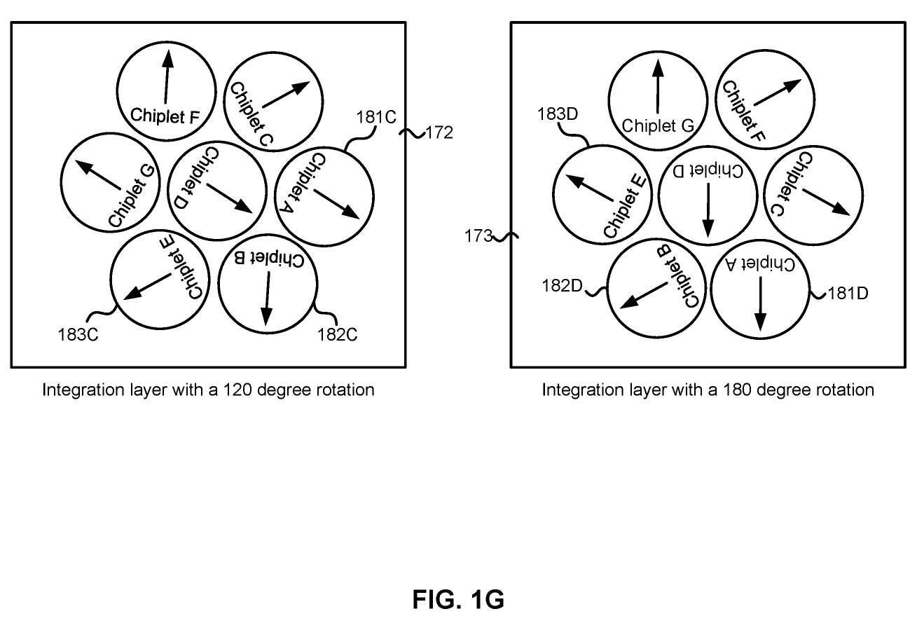

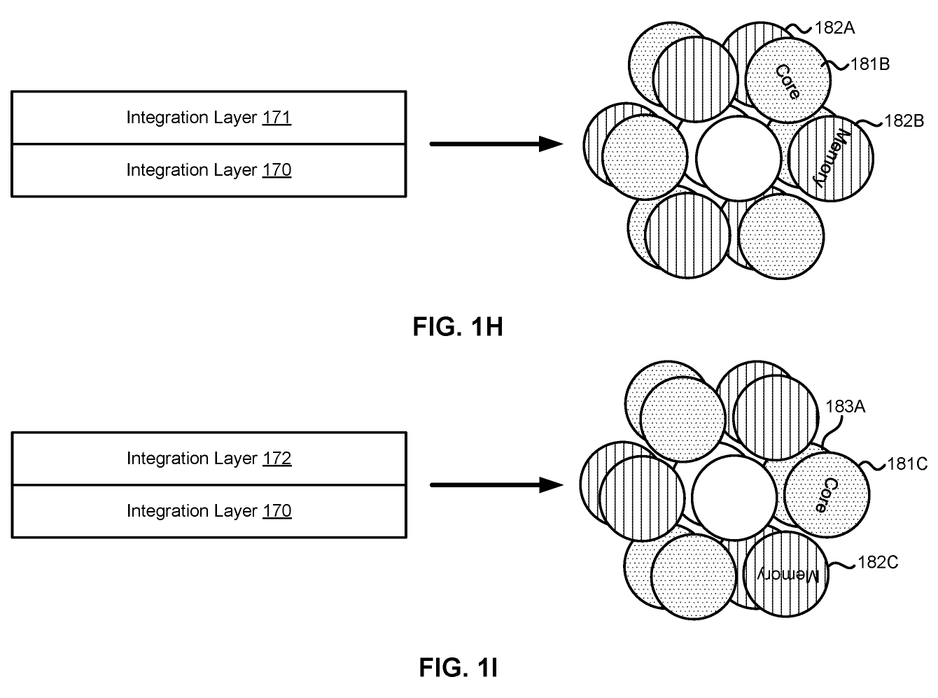

FIG. 1A depicts embodiments of integration layers that include multiple chiplets with different degrees of rotation. As depicted, four different integration layers 120-123 are oriented with different degrees of rotation relative to the integration layer 120. The integration layer 120 comprises a base integration layer from which the degree of rotation for the other integration layers 121-123 is determined. In some cases, each integration layer includes a substrate or interposer (e.g., a silicon interposer) not depicted onto which the chiplets 110-113 are bonded or attached.

The integration layer 120 includes four chiplets 110A-113A. The integration layer 121 includes four chiplets 110B-113B. The integration layer 122 includes four chiplets 110C-113C. The integration layer 123 includes four chiplets 110D-113D. In some cases, each of the chiplets 110-113 comprises a different type of die (e.g., memory die, CPU/GPU die, FPGA die, and hardware accelerator die). A 90-degree rotation of integration layer 120 causes chiplet 110A (Chiplet A) to move from the top left-most chiplet to the top right-most chiplet, and to have an East pointing orientation. A 180-degree rotation of integration layer 120 causes chiplet 110A (Chiplet A) to move from the top left-most chiplet to the bottom right-most chiplet, and to have a South pointing orientation. A 270-degree rotation of integration layer 120 causes chiplet 110A (Chiplet A) to move from the top left-most chiplet to the bottom left-most chiplet, and to have a West pointing orientation.

FIGS. 1B-1C depict embodiments of side views of vertically adjacent integration layers. As depicted in FIG. 1B, integration layer 121 is arranged above integration layer 120. Integration layer 121 comprises chiplets 113B and 110B separated by a horizontal spacing (e.g., 10mm) and integration layer 120 comprises chiplets 110A and 111A separated by the horizontal spacing. The chiplet 113B is stacked vertically above the chiplet 110A with a vertical spacing (e.g., 50mm) that is significantly smaller than the horizontal spacing (e.g., 10mm). In one example, the horizontal spacing is at least 20 times greater than the vertical spacing. In another example, the horizontal spacing is at least 100 times greater than the vertical spacing. In cases where the vertical spacing is significantly less than the horizontal spacing, the vertical alignment of chiplets that are in electrical communication with each other may significantly reduce data latency between the vertically aligned chiplets.

As depicted in FIG. 1C, integration layer 122 is arranged above integration layer 120. Integration layer 122 comprises chiplets 112C and 113C separated by a horizontal spacing (e.g., 8mm) and integration layer 120 comprises chiplets 110A and 111A separated by the horizontal spacing. The chiplet 112C is stacked vertically above the chiplet 110A with a vertical spacing (e.g., 100mm) that is significantly smaller than the horizontal spacing (e.g., 8mm).

FIGS. 1D-1E depict embodiments of top plan views of vertically adjacent integration layers. In some cases, multiple vertically adjacent integration layers including integration layers 120-123 are electrically connected using through-silicon vias (TSVs), through-chip vias, solder balls or bumps, micro-bumps, redistribution layers, wire bonds, or other means of providing vertical electrical connections. In some embodiments, an interposer is used to provide electrical connections between chiplets within a packaged system or between chiplets located on different integration layers. Interposers may comprise active interposers with active circuitry (e.g., DC-DC converters or I/O interface controllers) or passive interposers.

In some cases, multiple vertically adjacent integration layers including integration layers 120-123 are electrically connected using through-silicon vias (TSVs), through-chip vias, solder balls or bumps, micro-bumps, redistribution layers, wire bonds, or other means of providing vertical electrical connections. In some embodiments, an interposer is used to provide electrical connections between chiplets within a packaged system or between chiplets located on different integration layers. Interposers may comprise active interposers with active circuitry (e.g., DC-DC converters or I/O interface controllers) or passive interposers.

FIG. 1D depicts integration layer 121 arranged on top of integration layer 120. The 90-degree rotation of integration layer 121 causes the core chiplet 110B of integration layer 121 to be vertically aligned with memory chiplet 111A of integration layer 120 and memory chiplet 112B of integration layer 121 to be vertically aligned with core chiplet 113A of integration layer 120. In this case, the core chiplet 110B is positioned above the memory chiplet 111A.

FIG. 1E depicts integration layer 122 arranged on top of integration layer 120. The 180-degree rotation of integration layer 122 causes the core chiplet 113C of integration layer 122 to be vertically aligned with memory chiplet 111A of integration layer 120 and memory chiplet 111C of integration layer 122 to be vertically aligned with core chiplet 113A of integration layer 120. In this case, the core chiplet 113C is positioned above the memory chiplet 111A.

Although it’s common that the wafers used to fabricate die are circular, the die themselves are typically rectangular. However, some wafer dicing techniques, such as mechanical sawing, laser cut dicing, and plasma dicing allow for other die shapes, such as circular die shapes and hexagonal die shapes. The systems and methods disclosed herein apply to chiplets of various sizes and shapes, including rectangular die, hexagonal die, and/or circular die. In some embodiments, some of the integration layers contain a mixture of chiplets that provide different types of functionality (e.g., multi-core processor die, volatile memory die, and non-volatile memory die) and comprise chiplets of different non-rectangular shapes and sizes. In some embodiments, the chiplets located within an integration layer comprise circuitry built using mini-wafers (e.g., 2-inch wafers) that are not diced.

FIGS. 1F-1G depict embodiments of integration layers that include multiple chiplets that are of a circular shape with different degrees of rotation. In some cases, multiple vertically adjacent integration layers including integration layers 170-173 are electrically connected using through-silicon vias (TSVs), through-chip vias, solder balls or bumps, micro-bumps, redistribution layers, wire bonds, or other means of providing vertical electrical connections. As depicted, four different integration layers 170-173 are oriented with different degrees of rotation relative to the integration layer 170 (or the base integration layer). The integration layer 170 includes seven chiplets including chiplets 181A-183A. The integration layer 171 includes seven chiplets including chiplets 181B-183B. The integration layer 172 includes seven chiplets including chiplets 181C-183C. The integration layer 173 includes seven chiplets including chiplets 181D-183D. In some cases, each of the seven chiplets comprise different types of die (e.g., memory die, CPU/GPU die, and hardware accelerator die). In other cases, the seven chiplets comprise core chiplets and memory chiplets.

As depicted in FIGS. 1F-1G, a 60-degree rotation of integration layer 170 causes chiplet 181A (Chiplet A) to move from the top left-most chiplet to the top right-most chiplet. A 120-degree rotation of integration layer 170 causes chiplet 181A (Chiplet A) to move from the top left-most chiplet to the right-most chiplet. A 180-degree rotation of integration layer 170 causes chiplet 181A (Chiplet A) to move from the top left-most chiplet to the bottom right-most chiplet. Rotations of 60 degrees, 120 degrees, 180 degrees, 240 degrees, and 300 degrees allow the chiplet 181A of integration layer 170 to be vertically aligned with five other chiplets within other integration layers.

FIGS. 1H-1I depict embodiments of vertically adjacent integration layers, wherein the integration layers include chiplets with non-rectangular shapes. In some cases, vertically adjacent integration layers are electrically connected using through-silicon vias (TSVs), through-chip vias, solder balls or bumps, micro-bumps, wire bonds, or other means of providing vertical electrical connections. In some embodiments, one or more interposers are used to provide electrical connections between chiplets within a packaged system or between chiplets arranged within different integration layers.

FIG. 1H depicts integration layer 171 arranged on top of integration layer 170. The 60-degree rotation of integration layer 171 causes the core chiplet 181B of integration layer 171 to be vertically aligned with memory chiplet 182A of integration layer 170. In this case, the core chiplet 181B is positioned above the memory chiplet 182A.

FIG. 1I depicts integration layer 172 arranged on top of integration layer 170. The 120-degree rotation of integration layer 172 causes the core chiplet 181C of integration layer 172 to be vertically aligned with core chiplet 183A of integration layer 170. In this case, the core chiplet 181C is positioned above the core chiplet 183A.

In some embodiments, the integration layer 172 is rotated and then bonded to the integration layer 170 during manufacturing of an integrated circuit structure.

In some embodiments, multiple integration layers in an advanced IC packaging system are rotated and then arranged in a vertical stack of integration layers. Examples of advanced packaging systems include 2.5D IC packaging structures and 3D IC packaging structures. A common substrate or interposer is typically used to electrically connect chiplets within a 2.5D IC packaging structure without requiring that the chiplets be vertically stacked. In some cases, each of the integration layers include multiple chiplets and the chiplets have rectangular and/or non-rectangular shapes, such as pentagon shapes, hexagon shapes, and circular shapes.

In some embodiments, prior to a second integration layer being rotated and positioned above a first integration layer, an interposer between the two integration layers is configured for the degree of rotation of the second integration layer. In some cases, the interposer includes signal buffering and multiplexor circuitry to support the degree of rotation. In some cases, the interposer is configured to support one of four different degrees of rotation (e.g., 0 degree, 90 degree, 180 degree, and 270 degree rotations). In one embodiment, the configuration settings for the interposer are configured using fuses (or fuse bits) or non-volatile memory. In one example, top metal laser fuses are used to configure the interposer for one of four orientations.

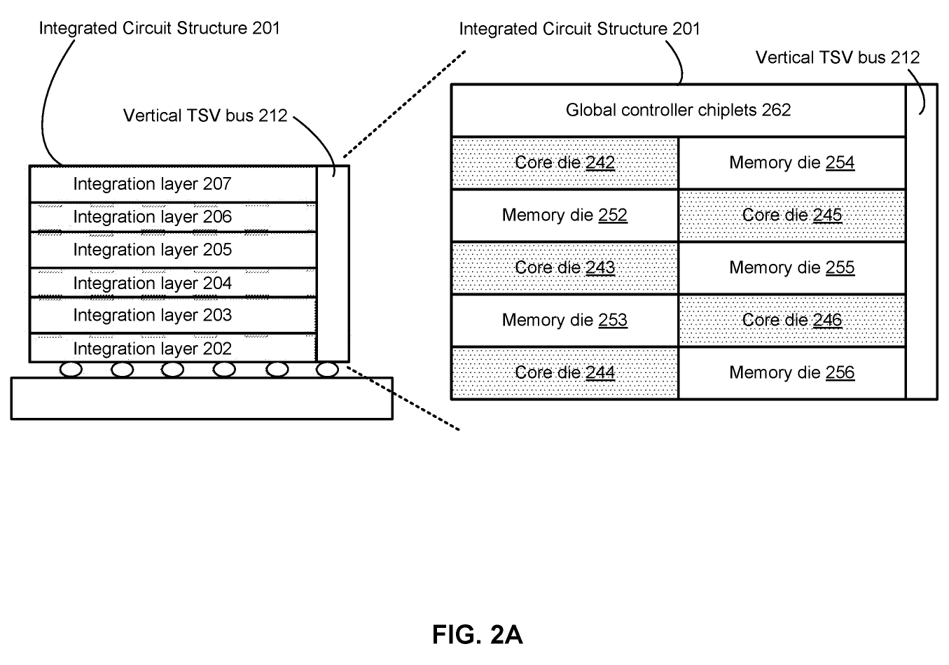

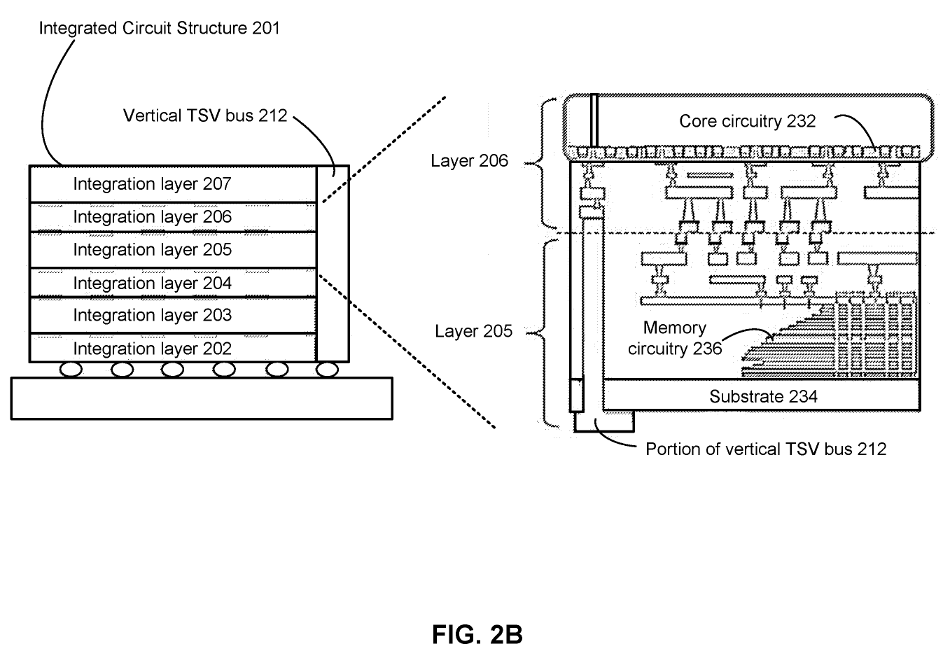

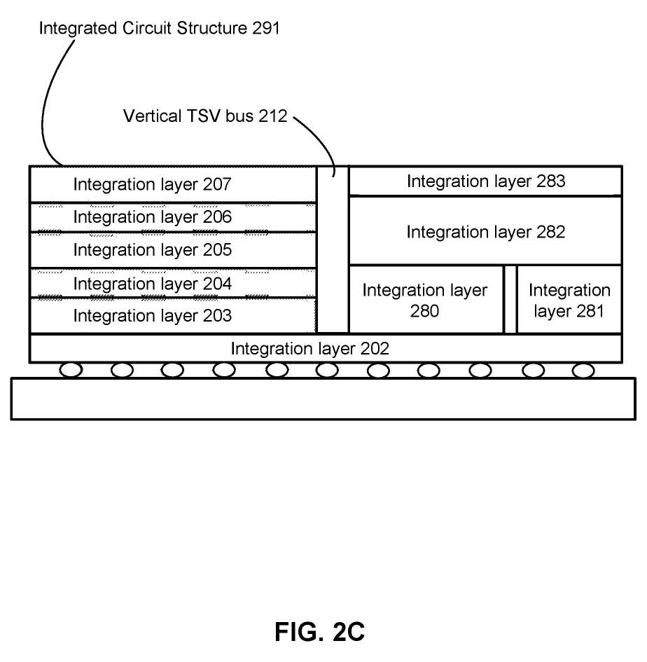

FIG. 2A depicts one embodiment of an integrated circuit structure that includes multiple integration layers. As depicted, the integrated circuit structure 201 includes vertically stacked integration layers 202-207 that are in electrical communication with each other via vertical TSV bus 212. The integration layer 202 includes core die 244 and memory die 256. The integration layer 203 includes core die 246 and memory die 253. The integration layer 204 includes core die 243 and memory die 255. The integration layer 205 includes core die 245 and memory die 252. The integration layer 206 includes core die 242 and memory die 254. The integration layer 207 includes global controller chiplets 262 that provides global functionality for the integrated circuit structure 201. As depicted in FIG. 2A, the core die 242-246 and the memory die 252-256 are interdigitated to maximize thermal gradients between chiplets and to prevent heat concentration within the integrated circuit structure 201.

FIG. 2B depicts one embodiment of a portion of an integrated circuit structure that includes multiple integration layers. As depicted, the integration layer 206 includes core circuitry 232 associated with the core die 242 in FIG. 2A and integration layer 205 includes memory circuitry 236 associated with the memory die 252 in FIG. 2A. The integration layer 205 includes a substrate 234 to support the memory circuitry 236. The vertical TSV connections corresponding to the vertical TSV bus 212 allow electrical connections to span two or more adjacent integration layers within the integrated circuit structure 201. In some cases, the vertical TSV bus 212 comprises configurable electrical connections that utilize a crossbar structure or transistor-based multiplexors.

As depicted in FIG. 2B, the integration layer 206 is flipped such that its substrate is positioned above the interconnect layers for the chiplets within the integration layer 206. An electrical connection comprising a portion of the vertical TSV bus 212 extends from the core circuitry 232 through the substrate 234 of the integration layer 205 using a TSV. Although the vertical TSV bus 212 is depicted as extending along one side of the integrated circuit structure 201, other vertical TSV busses and electrical connections may extend through other portions (e.g., a middle portion) of the integrated circuit structure 201.

FIG. 2C depicts an alternative embodiment of a portion of an integrated circuit structure that includes multiple integration layers. As depicted, the integrated circuit structure 291 includes a first vertical stack of integration layers comprising integration layers 203-207 and a second vertical stack of integration layers comprising integration layers 280-283 disposed above integration layer 202.

In some cases, each integration layer of the integration layers 280-281 has a greater thickness or layer height compared with integration layer 203. In some cases, each integration layer of the integration layers 280-281 has a smaller width compared with integration layer 203. Integration layer 282 is disposed above integration layers 280-281. The vertical TSV bus 212 may distribute electrical signal and power connections between the chiplets within the first vertical stack of integration layers and the second vertical stack of integration layers.

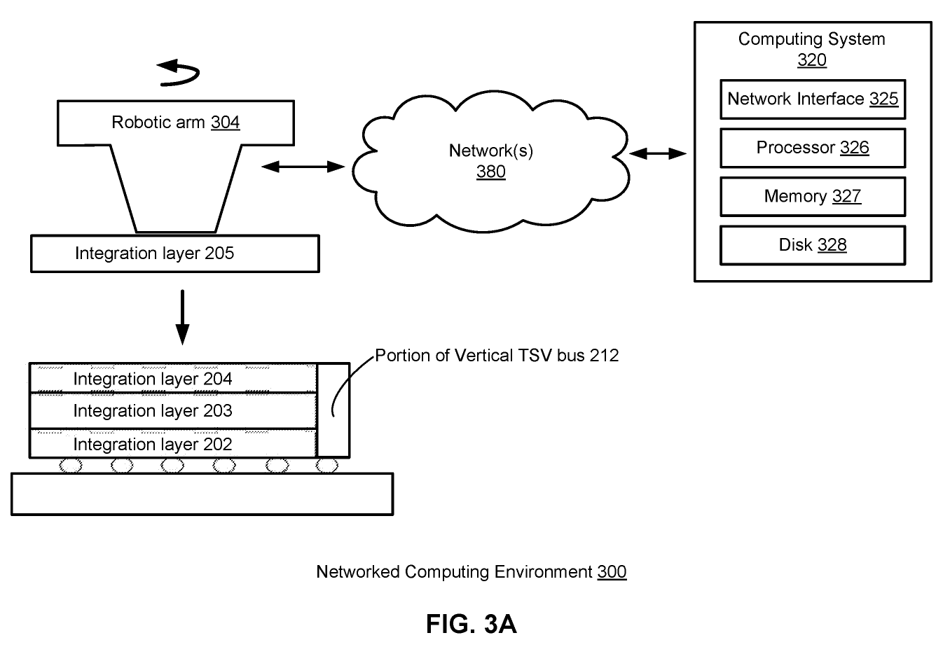

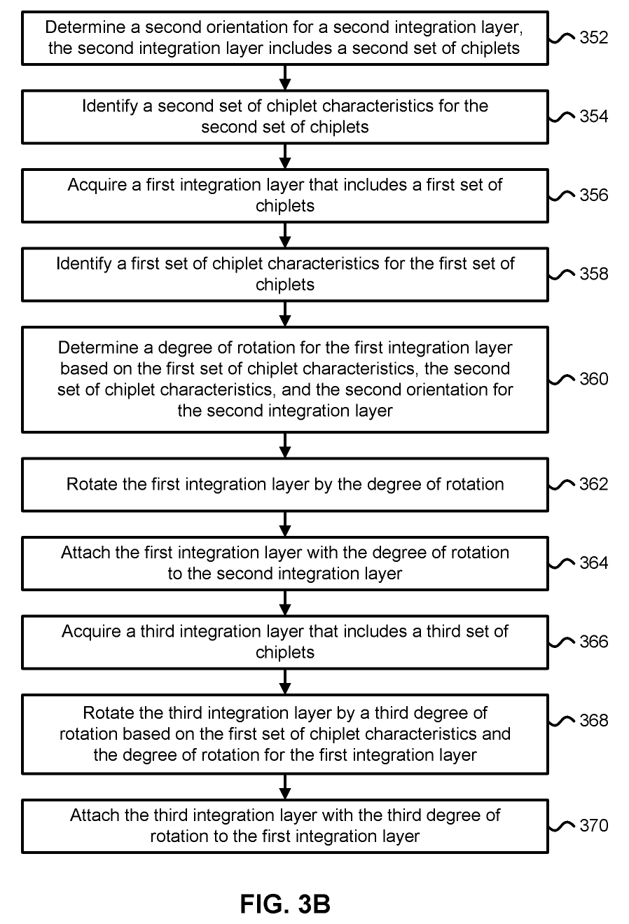

FIG. 3A depicts one embodiment of a networked computing environment 300 in which the disclosed technology may be practiced. The networked computing environment 300 includes a computing system 320 and a robotic arm 304 in communication with each other via one or more networks 380. In some cases, the networked computing environment 300 corresponds with or provides access to a cloud computing environment providing Software-as-a-Service (SaaS) or Infrastructure-as-a-Service (IaaS) services. The one or more networks 380 allow computing devices and/or storage devices to connect to and communicate with other computing devices and/or other storage devices. In some cases, the networked computing environment 300 includes other computing and storage devices interconnected through the one or more networks 380. As examples, the other computing devices include a mobile computing device, a non-mobile computing device, a server, a workstation, a laptop computer, a tablet computer, a desktop computer, or an information processing system. The other storage devices include a storage area network storage device, a networked-attached storage device, a hard disk drive, a solid-state drive, a data storage system, or a cloud-based data storage system. In some cases, the one or more networks 380 include a cellular network, a mobile network, a wireless network, a wired network, a secure network such as an enterprise private network, an unsecure network such as a wireless open network, a local area network (LAN), a wide area network (WAN), the Internet, or a combination of networks.

In some embodiments, the computing devices within the networked computing environment 300 comprise real hardware computing devices or virtual computing devices, such as one or more virtual machines. In some embodiments, the storage devices within the networked computing environment 300 comprise real hardware storage devices or virtual storage devices, such as one or more virtual disks. In one example, the real hardware storage devices include non-volatile and volatile storage devices.

As depicted in FIG. 3A, the computing system 320 includes a network interface 325, processor 326, memory 327, and disk 328 all in communication with each other. The network interface 325, processor 326, memory 327, and disk 328 may comprise real components and/or virtualized components. In some cases, the network interface 325, processor 326, memory 327, and disk 328 are provided by a virtualized infrastructure or a cloud-based infrastructure. Network interface 325 allows the computing system 320 to connect to the one or more networks 380. In one example, the network interface 325 comprises a wireless network interface and/or a wired network interface. Processor 326 allows the computing system 320 to execute computer readable instructions stored in memory 327 in order to perform processes described herein. In one example, the processor 326 comprises one or more processing units, such as one or more CPUs, one or more GPUs, and/or one or more NPUs. In one example, the memory 327 comprises one or more types of memory (e.g., RAM, SRAM, DRAM, EEPROM, Flash). In one example, the disk 328 comprises a hard disk drive and/or a solid-state drive. Memory 227 and disk 228 may comprise hardware storage devices.

As depicted in FIG. 3A, the computing system 320 is in communication with the robotic arm 304 that handles and positions chiplets and integration layers. In some embodiments, the robotic arm 304 transfers, rotates, and positions chiplets and/or integration layers during manufacturing of an integrated circuit structure. In one example, the robotic arm 304 rotates and arranges the integration layer 205 on top of the integration layer 204 during manufacturing of the integrated circuit structure 201 in FIG. 2A.

FIG. 3B depicts a flowchart describing one embodiment of a process for manufacturing an integrated circuit structure with rotatable chiplets. In one embodiment, the process of FIG. 3B is performed using a computing system, such as the computing system 320 in FIG. 3A, in communication with automated components, such as the robotic arm 304 in FIG. 3A. In another embodiment, the process of FIG. 3B is performed using a cloud computing infrastructure in communication with automated wafer and package processing equipment.

In step 352, a second orientation for a second integration layer is determined. The second integration layer includes a second set of chiplets. In one example, the second integration layer corresponds to the integration layer 204 in FIG. 3A and the second set of chiplets includes core die 243 in FIG. 2A and memory die 253 in FIG. 2A.

In step 354, a second set of chiplet characteristics for the second set of chiplets is identified. In some embodiments, the second set of chiplet characteristics include a number of chiplet defects for the second set of chiplets, chiplet performance metrics for the second set of chiplets (e.g., the clock frequency or the number of usable cores), chiplet capacity metrics for the second set of chiplets (e.g., the usable memory size), and/or chiplet thermal metrics for the second set of chiplets (e.g., the average chiplet temperature or maximum operating temperature).

In step 356, a first integration layer that includes a first set of chiplets is acquired. In one example, the first integration layer corresponds to the integration layer 205 in FIG. 3A and the first set of chiplets includes core die 245 in FIG. 2A and memory die 252 in FIG. 2A.

In step 358, a first set of chiplet characteristics for the first set of chiplets is identified. In some embodiments, the first set of chiplet characteristics include a number of chiplet defects for the first set of chiplets, chiplet performance metrics for the first set of chiplets (e.g., the clock frequency or the number of usable cores), chiplet capacity metrics for the first set of chiplets (e.g., the usable memory size), and/or chiplet thermal metrics for the first set of chiplets (e.g., the average chiplet temperature or maximum operating temperature).

In step 360, a degree of rotation for the first integration layer is determined based on the first set of chiplet characteristics, the second set of chiplet characteristics, and/or the second orientation for the second integration layer.

In some cases, the first set of chiplets and the second set of chiplets are classified as 100% chiplet versions or 75% chiplet versions. In one embodiment, the degree of rotation is set such that the maximum number of 100% chiplet versions between the first integration layer and the second integration layer are vertically aligned. In another embodiment, the degree of rotation is set such that the highest performing chiplets between the first integration layer and the second integration layer are vertically aligned. In one example, the highest performing chiplets correspond to the chiplets with the highest clock frequencies and/or number of usable cores. In another example, the highest performing chiplets correspond to the chiplets with the greatest amount of usable memory capacity or data storage and/or the highest memory bandwidth.

In step 362, the first integration layer is rotated by the degree of rotation. In one embodiment, the degree of rotation is performed by the robotic arm 304 in FIG. 3A. In step 364, the first integration layer with the degree of rotation is attached to or bonded to the second integration layer.

In step 366, a third integration layer that includes a third set of chiplets is acquired. In step 368, the third integration layer is rotated by a third degree of rotation based on the first set of chiplet characteristics and the degree of rotation for the first integration layer. In step 370, the third integration layer with the third degree of rotation is attached to the first integration layer.

In one example, the third integration layer corresponds to the integration layer 206 in FIG. 2A, the first integration layer corresponding to the integration layer 205 in FIG. 2A, and the second integration layer corresponding to the integration layer 204 in FIG. 2A.

At least one embodiment of the disclosed technology includes an integrated circuit structure comprising a first integration layer that includes a first set of chiplets, the first set of chiplets is associated with a first set of chiplet characteristics; and a second integration layer that includes a second set of chiplets, the second set of chiplets is associated with a second set of chiplet characteristics, the second integration layer is disposed above the first integration layer and rotated relative to the first integration layer based on the first set of chiplet characteristics and the second set of chiplet characteristics. In one embodiment, the first set of chiplets comprises a first plurality of chiplets and the second set of chiplets comprises a second plurality of chiplets.

In some cases, the second integration layer is positioned with a degree of rotation relative to the first integration layer such that a first chiplet of the first set of chiplets with the highest chiplet performance metric among the first set of chiplets is vertically aligned with a second chiplet of the second set of chiplets with the highest chiplet performance metric among the second set of chiplets.

At least one embodiment of the disclosed technology includes a method for manufacturing an integrated circuit structure comprising determining a second orientation for a second integration layer, the second integration layer includes a second set of chiplets; identifying a second set of chiplet characteristics for the second set of chiplets; acquiring a first integration layer that includes a first set of chiplets; identifying a first set of chiplet characteristics for the first set of chiplets; determining a degree of rotation for the first integration layer based on the first set of chiplet characteristics, the second set of chiplet characteristics, and the second orientation for the second integration layer; rotating the first integration layer by the degree of rotation; and attaching the first integration layer with the degree of rotation to the second integration layer.

In some cases, the method further comprises acquiring a third integration layer that includes a third set of chiplets; rotating the third integration layer by a third degree of rotation based on the first set of chiplet characteristics and the degree of rotation for the first integration layer; and attaching the third integration layer with the third degree of rotation to the first integration layer.

In some cases, the method further comprises rotating the first integration layer such that a first chiplet of the first set of chiplets with the highest chiplet performance metric among the first set of chiplets is vertically aligned with a second chiplet of the second set of chiplets with the highest chiplet performance metric among the second set of chiplets.

In some cases, the method further comprises rotating the first integration layer such that a first chiplet of the first set of chiplets with the highest clock frequency among the first set of chiplets is vertically aligned with a second chiplet of the second set of chiplets with the highest clock frequency among the second set of chiplets.

In some cases, the method further comprises rotating the first integration layer such that a first chiplet of the first set of chiplets with the greatest number of usable cores among the first set of chiplets is vertically aligned with a second chiplet of the second set of chiplets with the greatest number of usable cores among the second set of chiplets.

In some cases, the method further comprises rotating the first integration layer such that a first chiplet of the first set of chiplets with the highest usable memory size among the first set of chiplets is vertically aligned with a second chiplet of the second set of chiplets with the highest usable memory size among the second set of chiplets.

In some cases, the method further comprises rotating the first integration layer to maximize thermal gradients between the first set of chiplets and the second set of chiplets.

At least one embodiment of the disclosed technology includes system for manufacturing an integrated circuit structure comprising a storage device for storing instructions that, when executed, cause the system to perform operations comprising acquiring a second integration layer that includes a second set of chiplets; identifying a second set of chiplet characteristics for the second set of chiplets; acquiring a first integration layer that includes a first set of chiplets; identifying a first set of chiplet characteristics for the first set of chiplets; determining a degree of rotation for the first integration layer based on the first set of chiplet characteristics and the second set of chiplet characteristics; rotating the first integration layer by the degree of rotation such that a first chiplet of the first set of chiplets with the highest chiplet performance metric among the first set of chiplets is vertically aligned with a second chiplet of the second set of chiplets with the highest chiplet performance metric among the second set of chiplets; and bonding the first integration layer with the degree of rotation to the second integration layer.

The disclosed technology may be described in the context of computer-executable instructions being executed by a computer or processor. The computer-executable instructions may correspond with portions of computer program code, routines, programs, objects, software components, data structures, or other types of computer-related structures that may be used to perform processes using a computer. Computer program code used for implementing various operations or aspects of the disclosed technology may be developed using one or more programming languages, including an object oriented programming language such as Java or C++, a function programming language such as Lisp, a procedural programming language such as the “C” programming language or Visual Basic, or a dynamic programming language such as Python or JavaScript. In some cases, computer program code or machine-level instructions derived from the computer program code may execute entirely on an end user’s computer, partly on an end user’s computer, partly on an end user’s computer and partly on a remote computer, or entirely on a remote computer or server.

The flowcharts and block diagrams in the figures provide illustrations of the architecture, functionality, and operation of possible implementations of systems, methods, and computer program products according to various aspects of the disclosed technology. In this regard, each step in a flowchart may correspond with a program module or portion of computer program code, which may comprise one or more computer-executable instructions for implementing the specified functionality. In some implementations, the functionality noted within a step may occur out of the order noted in the figures. For example, two steps shown in succession may, in fact, be executed substantially concurrently, or the steps may sometimes be executed in the reverse order, depending upon the functionality involved. In some implementations, steps may be omitted and other steps added without departing from the spirit and scope of the present subject matter. In some implementations, the functionality noted within a step may be implemented using hardware, software, or a combination of hardware and software. As examples, the hardware may include microcontrollers, microprocessors, field programmable gate arrays (FPGAs), and electronic circuitry.

For purposes of this document, the term “processor” may refer to a real hardware processor or a virtual processor, unless expressly stated otherwise. A virtual machine may include one or more virtual hardware devices, such as a virtual processor and a virtual memory in communication with the virtual processor.

For purposes of this document, a first layer may be over or above a second layer if zero, one, or more intervening layers are between the first layer and the second layer.

Two devices may be “in communication” if they are directly or indirectly connected so that they can communicate electronic signals between them.

For purposes of this document, it should be noted that the dimensions of the various features depicted in the figures may not necessarily be drawn to scale.

For purposes of this document, reference in the specification to “an embodiment,” “one embodiment,” “some embodiments,” “another embodiment,” and other variations thereof may be used to describe various features, functions, or structures that are included in at least one or more embodiments and do not necessarily refer to the same embodiment unless the context clearly dictates otherwise.

For purposes of this document, a connection may be a direct connection or an indirect connection (e.g., via another part). In some cases, when an element is referred to as being connected or coupled to another element, the element may be directly connected to the other element or indirectly connected to the other element via intervening elements. When an element is referred to as being directly connected to another element, then there are no intervening elements between the element and the other element.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify or distinguish separate objects.

For purposes of this document, the term “set” of objects may refer to a “set” of one or more of the objects.

For purposes of this document, the phrases “a first object corresponds with a second object” and “a first object corresponds to a second object” may refer to the first object and the second object being equivalent, analogous, or related in character or function.

For purposes of this document, the term “or” should be interpreted in the conjunctive and the disjunctive. A list of items linked with the conjunction “or” should not be read as requiring mutual exclusivity among the items, but rather should be read as “and/or” unless expressly stated otherwise. The terms “at least one,” “one or more,” and “and/or,” as used herein, are open-ended expressions that are both conjunctive and disjunctive in operation. The phrase “A and/or B” covers embodiments having element A alone, element B alone, or elements A and B taken together. The phrase “at least one of A, B, and C” covers embodiments having element A alone, element B alone, element C alone, elements A and B together, elements A and C together, elements B and C together, or elements A, B, and C together. The indefinite articles “a” and “an,” as used herein, should typically be interpreted to mean “at least one” or “one or more,” unless expressly stated otherwise.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An integrated circuit structure, comprising:
a first integration layer that includes a first set of chiplets, the first set of chiplets is associated with a first set of chiplet characteristics; and
a second integration layer that includes a second set of chiplets, the second set of chiplets is associated with a second set of chiplet characteristics, the second integration layer is disposed above the first integration layer and at least a portion of the second integration layer is rotated relative to the first integration layer.

2. The integrated circuit structure of claim 1, wherein:
the second integration layer is rotated relative to the first integration layer based on the first set of chiplet characteristics and the second set of chiplet characteristics.

3. The integrated circuit structure of claim 2, wherein:
the second integration layer is positioned with a degree of rotation relative to the first integration layer such that a first chiplet of the first set of chiplets with the highest chiplet performance metric among the first set of chiplets is vertically aligned with a second chiplet of the second set of chiplets with the highest chiplet performance metric among the second set of chiplets.

4. The integrated circuit structure of claim 2, wherein:
the second integration layer is positioned with a degree of rotation relative to the first integration layer such that a first chiplet of the first set of chiplets with the highest clock frequency among the first set of chiplets is vertically aligned with a second chiplet of the second set of chiplets with the highest clock frequency among the second set of chiplets.

5. The integrated circuit structure of claim 2, wherein:
the second integration layer is positioned with a degree of rotation relative to the first integration layer such that a first chiplet of the first set of chiplets with the greatest number of usable cores among the first set of chiplets is vertically aligned with a second chiplet of the second set of chiplets with the greatest number of usable cores among the second set of chiplets.

6. The integrated circuit structure of claim 2, wherein:
the second integration layer is positioned with a degree of rotation relative to the first integration layer such that a first chiplet of the first set of chiplets with the highest usable memory size among the first set of chiplets is vertically aligned with a second chiplet of the second set of chiplets with the highest usable memory size among the second set of chiplets.

7. The integrated circuit structure of claim 2, wherein:
the second integration layer is positioned with a degree of rotation relative to the first integration layer such that a first chiplet of the first set of chiplets with the highest memory bandwidth among the first set of chiplets is vertically aligned with a second chiplet of the second set of chiplets with the highest memory bandwidth among the second set of chiplets.

8. The integrated circuit structure of claim 2, wherein:
the second integration layer is positioned with a degree of rotation relative to the first integration layer based on chiplet thermal metrics for the first set of chiplets and the second set of chiplets.

9. The integrated circuit structure of claim 8, wherein:
the chiplet thermal metrics include maximum operating temperatures for the first set of chiplets and the second set of chiplets.

10. The integrated circuit structure of claim 1, wherein:
the second integration layer includes an active interposer;
the first set of chiplets includes non-rectangular heterogeneous die; and
the degree of rotation comprises a 60-degree rotation.

11. A method for manufacturing an integrated circuit structure, comprising:
determining a second orientation for a second integration layer, the second integration layer includes a second set of chiplets;
identifying a second set of chiplet characteristics for the second set of chiplets;
acquiring a first integration layer that includes a first set of chiplets;
identifying a first set of chiplet characteristics for the first set of chiplets;
determining a degree of rotation for the first integration layer based on the first set of chiplet characteristics, the second set of chiplet characteristics, and the second orientation for the second integration layer;
rotating at least a portion of the first integration layer by the degree of rotation; and
attaching the first integration layer with the degree of rotation to the second integration layer.

12. The method of claim 11, further comprising:
acquiring a third integration layer that includes a third set of chiplets;
rotating the third integration layer by a third degree of rotation based on the first set of chiplet characteristics and the degree of rotation for the first integration layer; and
attaching the third integration layer with the third degree of rotation to the first integration layer.

13. The method of claim 11, wherein:
the rotating the first integration layer by the degree of rotation includes rotating the first integration layer such that a first chiplet of the first set of chiplets with the highest chiplet performance metric among the first set of chiplets is vertically aligned with a second chiplet of the second set of chiplets with the highest chiplet performance metric among the second set of chiplets.

14. The method of claim 11, wherein:
the rotating the first integration layer by the degree of rotation includes rotating the first integration layer such that a first chiplet of the first set of chiplets with the highest clock frequency among the first set of chiplets is vertically aligned with a second chiplet of the second set of chiplets with the highest clock frequency among the second set of chiplets.

15. The method of claim 11, wherein:
the rotating the first integration layer by the degree of rotation includes rotating the first integration layer such that a first chiplet of the first set of chiplets with the greatest number of usable cores among the first set of chiplets is vertically aligned with a second chiplet of the second set of chiplets with the greatest number of usable cores among the second set of chiplets.

16. The method of claim 11, wherein:
the rotating the first integration layer by the degree of rotation includes rotating the first integration layer such that a first chiplet of the first set of chiplets with the highest usable memory size among the first set of chiplets is vertically aligned with a second chiplet of the second set of chiplets with the highest usable memory size among the second set of chiplets.

17. The method of claim 11, wherein:
the rotating the first integration layer by the degree of rotation includes rotating the first integration layer to maximize thermal gradients between the first set of chiplets and the second set of chiplets.

18. The method of claim 11, wherein:
the attaching the first integration layer with the degree of rotation to the second integration layer includes bonding the first integration layer to the second integration layer subsequent to rotating the first integration layer by the degree of rotation.

19. The method of claim 11, wherein:
the first set of chiplets includes circular die;
the degree of rotation comprises a 90-degree rotation; and
the rotating the first integration layer by the degree of rotation includes rotating the first integration layer using a robotic arm.

20. A system for manufacturing an integrated circuit structure, comprising:
a storage device for storing instructions that, when executed, cause the system to perform operations comprising:
acquiring a second integration layer that includes a second set of chiplets;
identifying a second set of chiplet characteristics for the second set of chiplets;
acquiring a first integration layer that includes a first set of chiplets;
identifying a first set of chiplet characteristics for the first set of chiplets;
determining a degree of rotation for the first integration layer based on the first set of chiplet characteristics and the second set of chiplet characteristics;
rotating the first integration layer by the degree of rotation such that a first chiplet of the first set of chiplets with the highest chiplet performance metric among the first set of chiplets is vertically aligned with a second chiplet of the second set of chiplets with the highest chiplet performance metric among the second set of chiplets; and
bonding the first integration layer with the degree of rotation to the second integration layer.
